(19) United States
(12) Patent Application Publication
(10) Pub. No.: US 2026/0257599 A1
(43) Pub. Date: Sep. 3, 2026

(54) SEATBACK AIR MOVING MACHINE PROTECTION STRUCTURE AND VEHICLE SEAT

(71) Applicants: NHK SPRING CO., LTD., Yokohama-shi, (JP); SUBARU CORPORATION, Tokyo (JP)

(72) Inventors: Hiroshi YAGAME, Yokohama-shi (JP); Kenzo YASUDA, Yokohama-shi (JP); Kazuhiro TOYOSHIMA, Yokohama-shi (JP); Shunki ANDO, Yokohama-shi (JP); Masato FUKUSHIMA, Tokyo (JP); Yosuke ISHIYAMA, Tokyo (JP)

(21) Appl. No.: 19/553,661

(22) Filed: Mar. 2, 2026

(30) Foreign Application Priority Data
Mar. 3, 2025 (JP) 2025-033232

(51) Int. Cl. B60N 2/56; B60N 2/06; B60N 2/22; B60N 2/66; B60N 2/68; B60N 2/809

(52) U.S. Cl. CPC B60N 2/565; B60N 2/06; B60N 2/22; B60N 2/5635; B60N 2/666; B60N 2/68; B60N 2/809

(57) ABSTRACT

A seatback air moving machine protection structure including left and right lumbar wires spanned between an upper section and a lower section of a seatback frame of a vehicle seat, an attachment wire supported by the left and right lumbar wires, an attachment bracket attached to the attachment wire, an air moving machine attached to a face on a seatback rear side of the attachment bracket, and a protection member that is formed in a strip shape, and that is arranged at the seatback rear side with respect to the air moving machine spanned between the left and right lumbar wires.

### CROSS-REFERENCE TO RELATED APPLICATION

This application is based on and claims priority under 35 USC 119 from Japanese Patent Application No. 2025-033232 filed on Mar. 3, 2025, the disclosure of which is incorporated by reference herein.

### BACKGROUND

### Technical Field

The present disclosure relates to a vehicle seat, and in particular to a seatback air moving machine protection structure.

### Related Art

A vehicle seat disclosed in Japanese Patent Application Laid-Open (JP-A) No. 2012-206649 is configured so as to protect an air moving unit attached to springs of a seatback using a covering member fixed to left and right vertical frames of a seatback frame. This covering member is configured in a strip plate shape from a resin.

### SUMMARY

However, in the related art described above, the resin covering member spans between the left and right vertical frames, and the covering member is bulky. There is accordingly room for improvement from the perspective of reducing an installation space of a covering member (air moving machine protection member) inside a seatback.

An object of the present disclosure is to obtain a seatback air moving machine protection structure and a vehicle seat that are capable of reducing the installation space inside a seatback of a protection member for protecting an air moving machine.

A seatback air moving machine protection structure of a first aspect of the present disclosure includes left and right lumbar wires spanned between an upper section and a lower section of a seatback frame of a vehicle seat, an attachment wire supported by the left and right lumbar wires, an attachment bracket attached to the attachment wire, an air moving machine attached to a face on a seatback rear side of the attachment bracket, and a protection member that is formed in a strip shape, and that is arranged at the seatback rear side with respect to the air moving machine spanned between the left and right lumbar wires, between left and right side portions of the attachment wire, or between left and right side portions of the attachment bracket.

In the seatback air moving machine protection structure of the first aspect, the left and right lumbar wires are spanned between the upper section and the lower section of the seatback frame of a vehicle seat. The attachment wire is supported by the left and right lumbar wires. The attachment bracket is attached to the attachment wire. The air moving machine is attached to the seatback rear side face of the attachment bracket. The protection member is formed in a strip shape, and is arranged at the seatback rear side with respect to the air moving machine spanned between the left and right lumbar wires, between the left and right side portions of the attachment wire, or between the left and right side portions of the attachment bracket. This thereby enables the air moving machine to be prevented or suppressed from detaching from the attachment bracket under excessive load from the seatback front side. Moreover, due to the protection member being spanned as described above, the installation space of the protection member can be reduced compared to configurations in which the protection member is spanned between left and right vertical frames of a seatback frame.

A seatback air moving machine protection structure of a second aspect is the first aspect, wherein the protection member is configured from a cloth-form material.

In the seatback air moving machine protection structure of the second aspect, the protection member can be made lighter because the protection member formed in a strip shape is configured from a cloth-form material. Moreover, the air moving machine can be protected from light loads input from the rear face side of the seatback.

A seatback air moving machine protection structure of a third aspect is the first aspect or the second aspect, wherein the protection member exhibits elasticity.

In the seatback air moving machine protection structure of the third aspect, the protection member formed in a strip shape from the cloth-form material exhibits elasticity and so the protection member is not liable to get in the way when, for example, the air moving machine is being attached to the attachment bracket. Moreover, the seating comfort of an occupant leaning against the seatback can be controlled by the elasticity of the protection member. Furthermore, due to the protection member extending during a rear-end collision of a vehicle, a configuration in which the ability to prevent whiplash of the head of the occupant is not affected can be achieved.

The seatback air moving machine protection structure of a fourth aspect is any one aspect of the first aspect to the third aspect, wherein the protection member is spanned between the left and right lumbar wires.

In the seatback air moving machine protection structure of the fourth aspect, the protection member formed in a strip shape is spanned between the left and right lumbar wires, and so rattling of the left and right lumbar wires with respect to the seatback frame can be suppressed. As a result thereof, vibration of the seatback arising from the air moving machine can be reduced.

A seatback air moving machine protection structure of a fifth aspect includes left and right lumbar wires spanned between an upper section and a lower section of a seatback frame of a vehicle seat, an attachment bracket supported by the left and right lumbar wires, an air moving machine attached to a face on a seatback rear side of the attachment bracket, and a protection member that is formed in a strip shape and is arranged at the seatback rear side with respect to the air moving machine spanned between the left and right lumbar wires.

In the seatback air moving machine protection structure of the fifth aspect, the left and right lumbar wires are spanned between the upper section and the lower section of the seatback frame of a vehicle seat. The attachment bracket is supported by the left and right lumbar wires. The air moving machine is attached to the seatback rear side face of the attachment bracket. The protection member formed in a strip shape is arranged at the seatback rear side with respect to the air moving machine spanned between the left and right lumbar wires. This thereby enables the air moving machine to be prevented or suppressed from detaching from the attachment bracket under excessive load from the seatback front side. Moreover, due to the protection member being spanned between the left and right lumbar wires, the installation space of the protection member can be reduced compared to a configuration in which the protection member is spanned between left and right vertical frames of the seatback frame.

A vehicle seat of a sixth aspect includes a seat cushion for an occupant of a vehicle to sit on, and a seatback to support a back of the occupant, wherein the seatback includes the seatback air moving machine protection structure of any one aspect of the first aspect to the fifth aspect.

In the vehicle seat of the sixth aspect, the back of an occupant seated on the seat cushion is supported by the seatback. The seatback includes the seatback air moving machine protection structure of any one aspect of the first aspect to the fifth aspect and so the advantageous effect described above are obtained.

As described above, the seatback air moving machine protection structure and the vehicle seat according to the present disclosure are able to reducing the installation space inside a seatback of a protection member for protecting an air moving machine.

### BRIEF DESCRIPTION OF THE DRAWINGS

Exemplary embodiments of the present invention will be described in detail based on the following figures, wherein:

FIG. 1 is a side view illustrating a vehicle seat according to a first exemplary embodiment;

FIG. 2 is a first perspective view illustrating part of a seatback of the same vehicle seat;

FIG. 3 is a second perspective view illustrating part of a seatback of the same vehicle seat;

FIG. 4 is a perspective view illustrating a lumbar wire, a lumbar support mechanism, an attachment wire, an attachment bracket, an air moving machine, and a rubber member;

FIG. 5 is a perspective view illustrating a lumbar wire, an attachment wire, an attachment bracket, an air moving machine, and a rubber member;

FIG. 6 is a perspective view illustrating an attachment bracket and an attachment wire;

FIG. 7 is a perspective view illustrating an attachment bracket;

FIG. 8 is a first perspective view illustrating an attachment wire;

FIG. 9 is a second perspective view illustrating an attachment wire;

FIG. 10 is a perspective view for explaining a state in which load from a seat front side has been imparted to an attachment bracket;

FIG. 11 is a perspective view illustrating part of a seatback of a vehicle seat according to a second exemplary embodiment; and

FIG. 12 is a perspective view illustrating part of a seatback of a vehicle seat according to a third exemplary embodiment of the present disclosure.

### DETAILED DESCRIPTION

### First Exemplary Embodiment

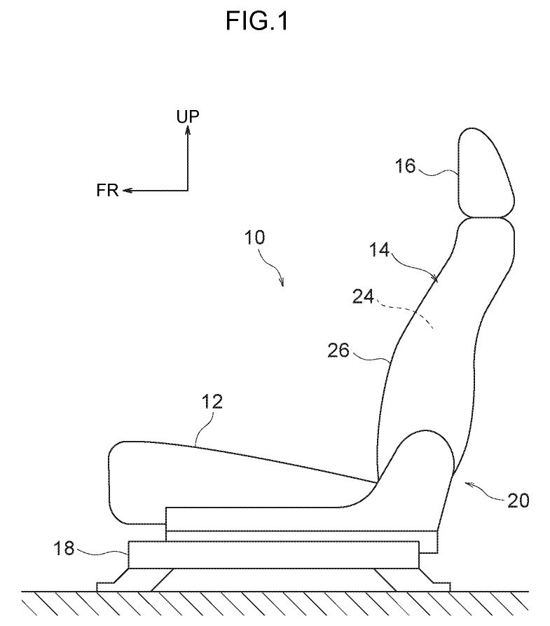

Description follows regarding a vehicle seat 10 according to a first exemplary embodiment of the present disclosure, with reference to FIG. 1 to FIG. 10. Note that sometimes some of the reference numerals are omitted in the drawings in order to make the drawings easier to read. Moreover, as appropriate in the drawings, the arrows FR, LH, RH, and UP respectively indicate forward, leftward, rightward, and upward directions of the vehicle seat 10. Hereinafter, when reference is simply given to front and rear, left and right, up and down in the following description then this indicates directions with respect to the vehicle seat 10.

As illustrated in FIG. 1, the vehicle seat 10 according to the present exemplary embodiment is, for example, a vehicle front seat, and includes a seat cushion 12 for an occupant of the vehicle to sit on, a seatback 14 to support the back of the occupant, and a headrest 16 to support the head of the occupant. The seat cushion 12 is coupled to a floor section of a vehicle through a known slide mechanism 18. A lower end portion of the seatback 14 is coupled to a rear end portion of the seat cushion 12 through a known reclining mechanism 20. The headrest 16 is coupled to an upper end portion of the seatback 14 so as to be adjustable in height position.

In a state in which the seatback 14 is positioned at the upright position illustrated in FIG. 1 with respect to the seat cushion 12, the front and rear, left and right, and up and down directions of the seatback 14 are aligned with the front and rear, left and right, and up and down directions of the vehicle seat 10. In the following explanation, when front and rear, left and right, and up and down directions are employed in relation to the seatback 14, these indicate directions when the seatback 14 is in a state positioned at the upright position.

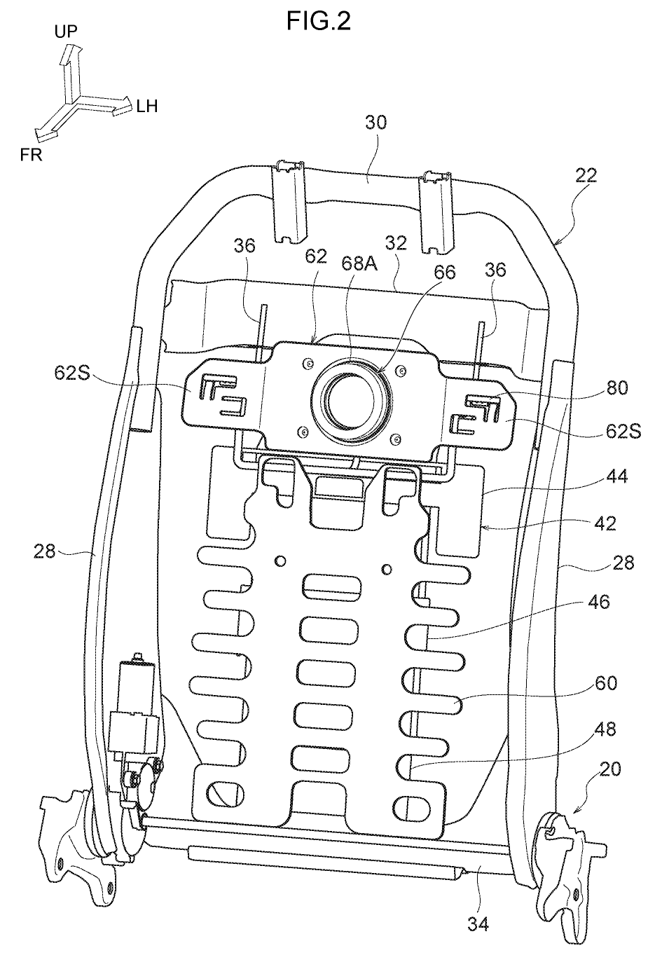

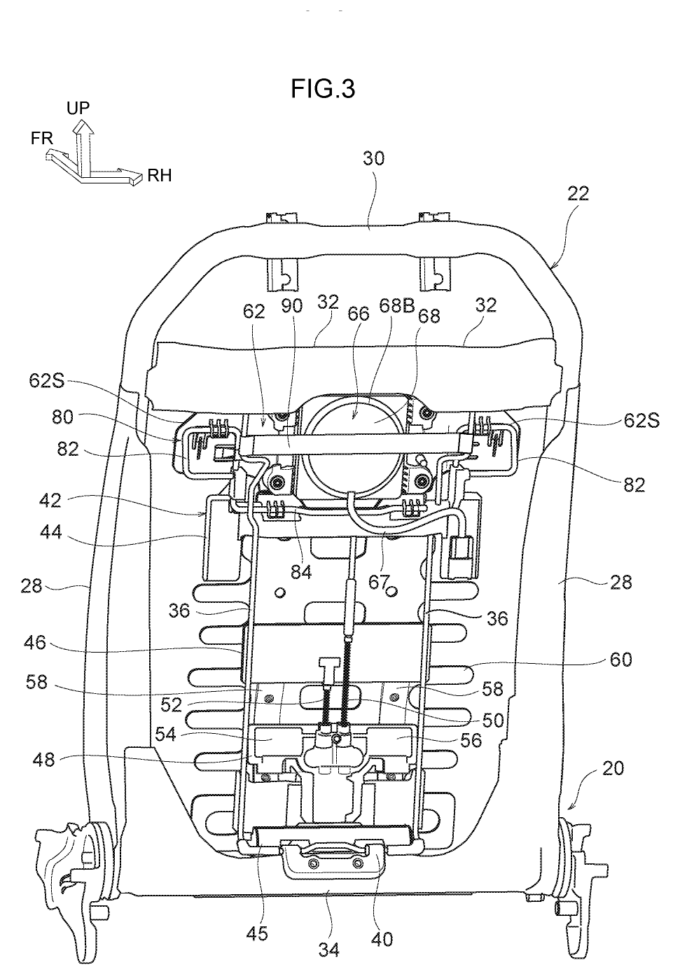

The seatback 14 includes a seatback frame 22 that is a framework member (see FIG. 2 and FIG. 3), a seatback pad 24 that is a cushion member (see FIG. 1), and a trim cover 26 that is a covering member (see FIG. 1). The seatback frame 22 includes left and right side frames 28, an upper frame 30 that connects upper end portions of the left and right side frames 28 together in the left-right direction, an upper bracket 32 attached to the upper frame 30, and a lower frame 34 that connects lower end portions of the left and right side frames 28 together in the left-right direction. The upper frame 30 and the upper bracket 32 are arranged in an upper section of the seatback 14, and the lower frame 34 is arranged in a lower section of the seatback 14.

The left and right side frames 28, the upper bracket 32, and the lower frame 34 are, for example, configured from metal plate blanks that have been press molded, and the upper frame 30 is, for example, configured from a metal pipe member that has been subjected to bend processing. The upper frame 30 is configured in a substantially inverted U-shape when viewed along the front-rear direction, and the upper bracket 32 spans across between left and right end portions of a lower section of the upper frame 30.

The seatback pad 24 is, for example, configured from a foam body of urethane foam or the like, and is covered over the seatback frame 22 from the upper side thereof. The trim cover 26 is, for example, formed in a bag shape by stitching together plural covering pieces of cloth material, leather, synthetic leather, or the like, and is covered over the seatback pad 24 from the upper side thereof.

Left and right lumbar wires 36 span between the upper bracket 32 provided to the upper section of the seatback frame 22, and the lower frame 34 provided to the lower end portion of the seatback 14. The left and right lumbar wires 36 extend in the height direction, and are arranged spaced apart from each other in the left-right direction. Upper end portions of the left and right lumbar wires 36 are inserted from below into non-illustrated through holes formed in the upper bracket 32. Lower end portions of the left and right lumbar wires 36 are coupled together in the left-right direction by a coupling wire 38, with the coupling wire 38 fixed to the lower frame 34. The left and right lumbar wires 36 and the coupling wire 38 are, for example, configured from a single strand of metal wire material. Note that a fixing member 40 fastened and fixed to the lower frame 34 is attached to the coupling wire 38.

A lumbar support mechanism 42 is attached to the left and right lumbar wires 36. The lumbar support mechanism 42 includes an upper side base 44 disposed in the upper section of the seatback 14, an upper side variable height section 46 disposed at a height direction intermediate portion of the seatback 14, a lower side variable height section 48 disposed at lower section of the seatback 14, and a lower side base 45 disposed at a lower end portion of the seatback 14. The upper side base 44, the upper side variable height section 46, the lower side variable height section 48, and the lower side base 45 are, for example, each manufactured from injection molded resin, and are formed in substantially plate shapes having a length direction aligned with the left-right direction and a plate thickness direction aligned with the front-rear direction.

The upper side base 44 is, for example, integrally molded together with the left and right lumbar wires 36, with the left and right side portions of the upper side base 44 fixed to the left and right lumbar wires 36. Left and right end portions of the upper side variable height section 46 and the lower side variable height section 48 are engaged so as to be slidable in the height direction with respect to the left and right lumbar wires 36. The lower side base 45 is, for example, integrally molded together with the coupling wire 38, with the coupling wire 38 embedded in the lower side base 45. The upper side base 44, the upper side variable height section 46, the lower side variable height section 48, and the lower side base 45 are coupled together through a feed screw 50, and the upper side variable height section 46 and the lower side variable height section 48 are coupled together through a feed screw 52. The feed screws 50, 52 are arranged with their axial directions aligned with the height direction.

Two motors 54, 56 are attached to the lower side variable height section 48. The feed screws 50, 52 are able to be rotated individually by these motors 54, 56. When the feed screw 50 is rotated by the motor 56, the upper side variable height section 46 and the lower side variable height section 48 are together raised or lowered (moved so as to approach or separate) with respect to the upper side base 44 and the lower side base 45. When the feed screw 52 is rotated by the motor 54, the upper side variable height section 46 is raised or lowered (moved so as to approach or separate) with respect to the lower side variable height section 48.

Left and right arch members 58 span between the upper side variable height section 46 and the lower side variable height section 48. The left and right arch members 58 are, for example, configured from a resilient metal or resin plate formed in strip shape with a length direction aligned with the height direction, and are each curved in a circular arc shape convex toward the front when viewed along the left-right direction. When the upper side variable height section 46 approaches the lower side variable height section 48 due to rotation of the motor 54, the curvature of the curve of the left and right arch members 58 becomes tighter, and height direction intermediate portions of the arch members 58 project forward. Moreover, when the upper side variable height section 46 separates from the lower side variable height section 48 due to rotation of the motor 54, the curvature of the curve of the left and right arch members 58 becomes less pronounced, and the height direction intermediate portions of the left and right arch members 58 retreat rearward.

A lumbar support plate 60 is arranged at a front side of the left and right arch members 58. The lumbar support plate 60 is, for example, configured by injection molded resin, and is formed in a substantially plate shape having a length direction aligned with the height direction and a thickness direction aligned with the front-rear direction. An upper end portion of the lumbar support plate 60 is coupled to the upper side base 44 through an attachment wire 80, described later. The lumbar support plate 60 contacts a back face of the seatback pad 24. The lumbar support plate 60 is displaced in the front-rear direction by changes to the curvature of the curve of the left and right arch members 58 configured as described above. This thereby results in a configuration such that a strength of support to the lumbar region of the occupant can be adjusted.

An attachment bracket 62 is arranged inside the seatback 14 above the lumbar support mechanism 42. The attachment bracket 62 is, for example, configured by injection molded resin in a plate shape, and is formed in a substantially plate shape having a length direction aligned with the left-right direction and a thickness direction aligned with the front-rear direction. The attachment bracket 62 is arranged at the front side with respect to the left and right lumbar wires 36, and is supported by the left and right lumbar wires 36 through the attachment wire 80 and the upper side base 44, as described later.

As illustrated in FIG. 2 to FIG. 5, an air moving machine 66 is attached to a left-right direction central portion of the attachment bracket 62. The air moving machine 66 is disposed at the rear side with respect to the attachment bracket 62. The air moving machine 66 is, for example, a centrifugal air moving machine, and includes a non-illustrated centrifugal fan having an axial direction aligned with the front-rear direction, and a case 68 housing the centrifugal fan. The case 68 is, for example, configured by injection molded resin, and is formed with a square shape when viewed from the front-rear direction, and thin in the front-rear direction.

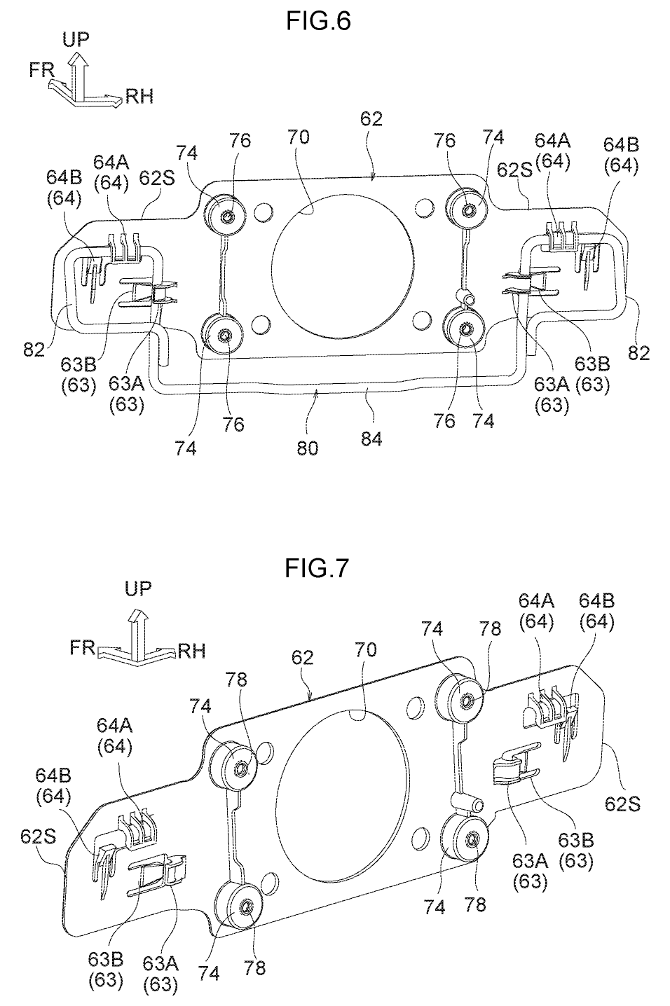

As illustrated in FIG. 6 and FIG. 7, a circular through hole 70 is formed in a left-right direction central portion of the attachment bracket 62. An air intake port 68A provided to the case 68 of the air moving machine 66 is inserted into the circular through hole 70. The air intake port 68A is formed in a circular cylindrical shape having an axial direction aligned with the front-rear direction, and is arranged contacting the back face of the seatback pad 24. Although not illustrated in the drawings, plural air intake holes are formed in the seatback pad 24 at locations facing toward the air intake port 68A.

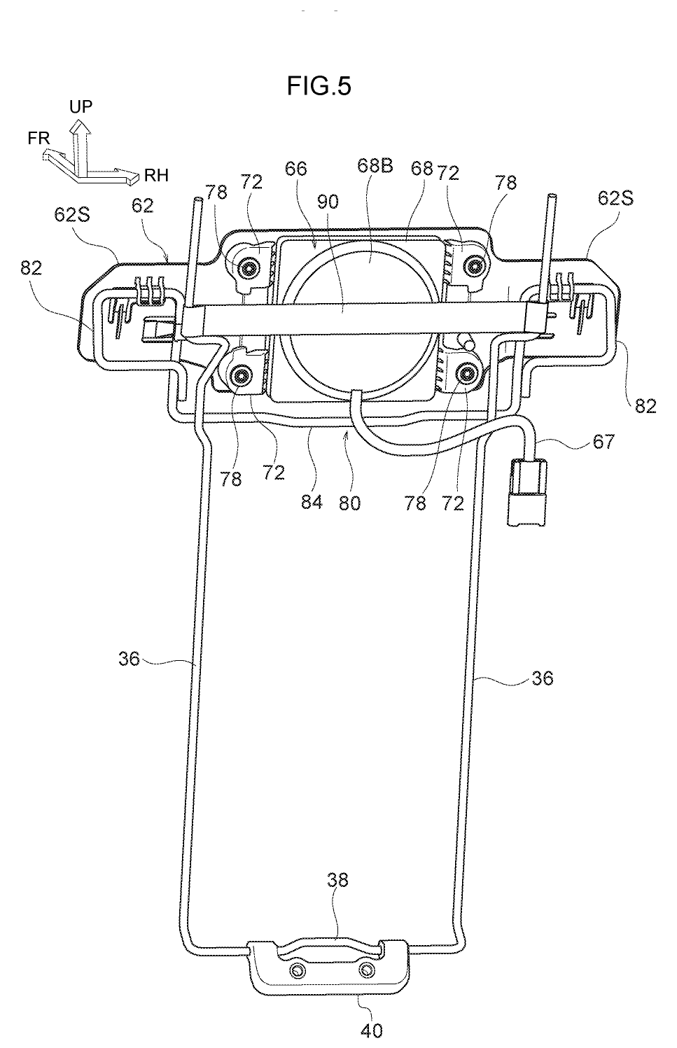

As illustrated in FIG. 3 and FIG. 5, a bottomed circular cylindrical shaped fan housing section 68B is provided to a rear portion of the case 68 with its axial direction aligned with the front-rear direction. The centrifugal fan is housed inside the fan housing section 68B. Plural non-illustrated air discharge ports are formed to a peripheral wall portion of the fan housing section 68B.

A non-illustrated motor for rotating the centrifugal fan is provided inside the case 68. This results in a configuration such that, when the centrifugal fan is rotated by this motor, air at a front face side (namely, the occupant side) of the seatback 14 is suctioned into the air intake port 68A through the plural air intake holes described above, and is then discharged through the plural air discharge holes described above. Note that reference numeral 67 in FIG. 3 to FIG. 5 indicates a harness for supplying power to the above motors.

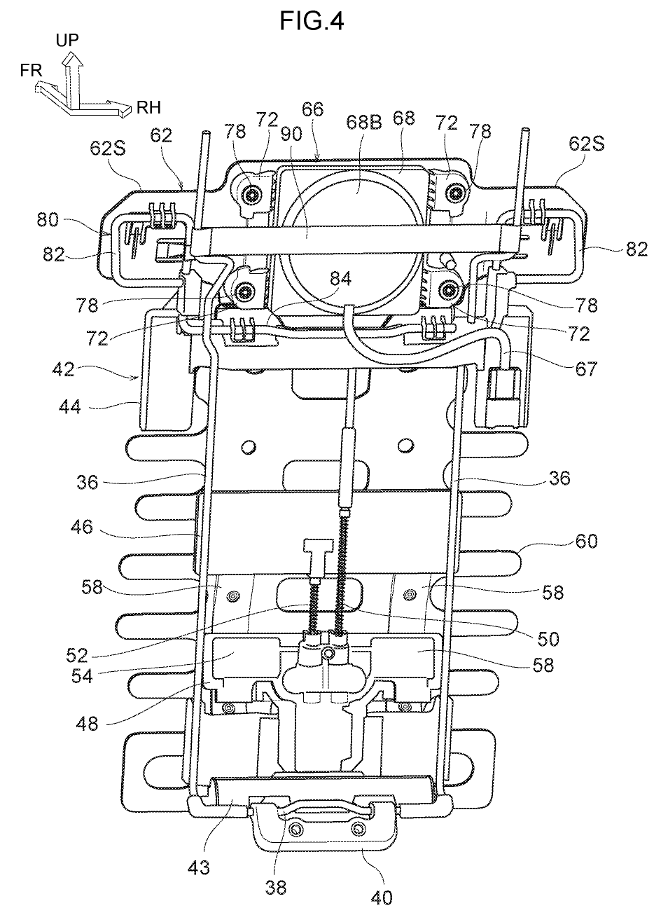

As illustrated in FIG. 4 and FIG. 5, two upper and lower fastening tabs 72 are provided to each of a left end portion and a right end portion of the case 68. Each of the fastening tabs 72 is formed in a plate shape having a plate thickness direction aligned with the front-rear direction, and a circular screw hole (omitted in the drawings) is formed to a central portion of the fastening tab 72. Four fastening seats 74 are formed to the attachment bracket 62 corresponding to the four fastening tabs 72 as illustrated in FIG. 6 and FIG. 7. The fastening seats 74 are each formed in a substantially cylindrical shape having an axial direction arranged along the front-rear direction.

Nuts 76 are embedded in the respective fastening seats 74 by, for example, insert molding. The fastening tabs 72 are superimposed on the respective fastening seats 74 from the rear side, and screws 78 (see FIG. 4 and FIG. 5) inserted into the screw holes in the fastening tabs 72 are threaded into the nuts 76 in the respective fastening seats 74. The air moving machine 66 is thereby attached to the rear face of the attachment bracket 62.

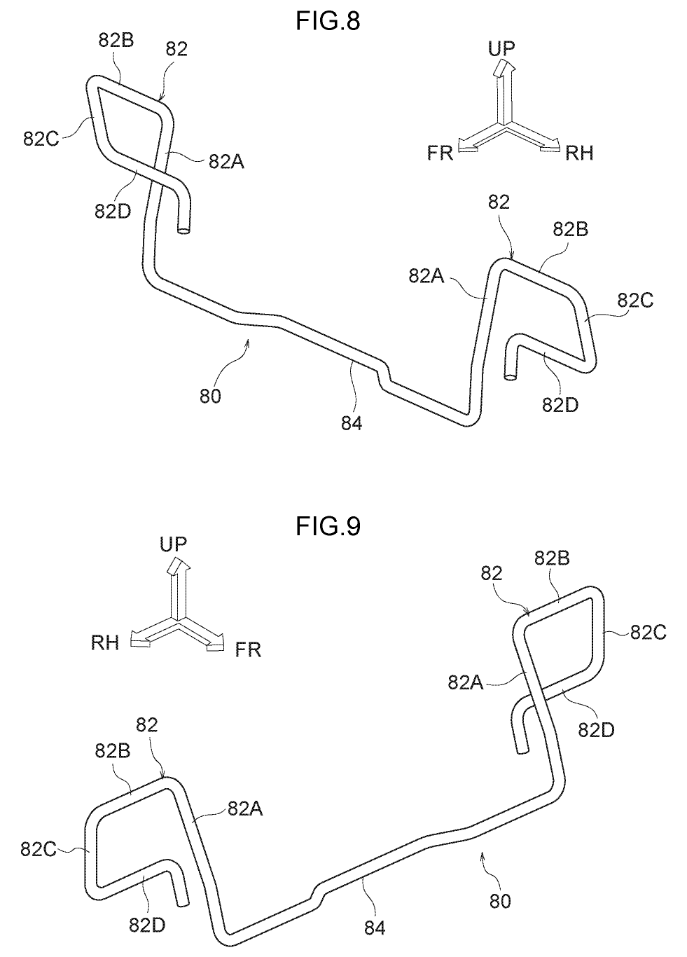

As illustrated in FIG. 3 and FIG. 4, the attachment bracket 62 is coupled to the upper side base 44 of the lumbar support mechanism 42 through the attachment wire 80. As illustrated in FIG. 8 and FIG. 9, the attachment wire 80 is a single body made by performing bend processing on a metal wire material and includes left and right attachment sections 82 and a coupling portion 84 coupling the left and right attachment sections 82 together in the left-right direction. The attachment wire 80 is integrally molded together with the upper side base 44.

The coupling portion 84 extends in the left-right direction, and a large part of the coupling portion 84 is embedded in the upper side base 44. Portions at the left and right sides of the coupling portion 84 are exposed from the upper side base 44, with an upper end portion of the lumbar support plate 60 anchored to these exposed portions. The left and right attachment sections 82 are integrally connected to the left and right end portions of the coupling portion 84 and are bent upward.

The left and right attachment sections 82 are arranged exposed at the upper side of the upper side base 44. Each of the attachment sections 82 includes a first vertical extension portion 82A that extends from an upper end portion of the upper side base 44 (namely, an upper end portion of the lumbar support mechanism 42) toward the seat upper side, a first horizontal extension portion 82B that extends from an upper end of the first vertical extension portion 82A toward the vehicle left-right direction outside, a second vertical extension portion 82C that extends downward from a left-right direction outside end portion of the first horizontal extension portion 82B, and a second horizontal extension portion 82D that extends from a lower end of the second vertical extension portion 82C toward the left-right direction inside and is connected to an upper end portion of the upper side base 44.

The first vertical extension portion 82A is inclined in a direction slightly rearward on progression upward, and the second vertical extension portion 82C is inclined in a direction slightly rearward on progression downward. The left-right direction inside end portions of the second horizontal extension portion 82D are arranged separated to the rear side with respect to the lower end portion of the first vertical extension portion 82A, and are bent downward. This bend portion of the second horizontal extension portion 82D is embedded inside the upper side base 44.

As illustrated in FIG. 6, first anchor claws 63 anchored to the first vertical extension portion 82A of the left and right attachment sections 82, and second anchor claws 64 anchored to the first horizontal extension portion 82B of the left and right attachment sections 82, are provided to left and right side portions 62S of the attachment bracket 62. The attachment bracket 62 is thereby attached to the attachment wire 80.

As illustrated in FIG. 6 and FIG. 7, the first anchor claws 63 include an inside anchor portion 63A engaged with the first vertical extension portion 82A from the left-right direction inside, and an outside anchor portion 63B engaged with the first vertical extension portion 82A from the left-right direction outside, and these clamp the first vertical extension portions 82A in the left-right direction. The second anchor claws 64 include an upper anchor portion 64A engaged with the first horizontal extension portion 82B from the upper side, and a lower anchor portion 64B engaged with the first horizontal extension portion 82B from the lower side, and these clamp the first horizontal extension portion 82B in the height direction. A configuration is accordingly achieved in which, for example, the outside anchor portion 63B resiliently deforms and then resiliently returns when the first anchor claws 63 are being anchored to the first vertical extension portion 82A and, for example, the upper anchor portion 64A resiliently deforms and then resiliently returns when the second anchor claws 64 are being anchored to the first horizontal extension portion 82B.

A rubber member 90 serving as a protection member spans between upper portions of the left and right lumbar wires 36. The rubber member 90 is formed in an elongated strip shape, and is disposed at a rear side of the air moving machine 66 oriented with its length direction along the left-right direction. The rubber member 90 is, for example, configured by a cloth-form material containing elastic threads, such as natural rubber threads, polyurethane threads, or the like, and exhibits elasticity (stretchability). The two length direction end portions of the rubber member 90 are wrapped around upper end portions of the left and right lumbar wires 36, with portions before and after the wrap joined together by a method such as sewing or the like. The two length direction end portions of the rubber member 90 are thereby anchored to the upper portions of the left and right lumbar wires 36. The rubber member 90 is able to move in the height direction relative to the left and right lumbar wires 36 within a specific range.

The rubber member 90 spans between the upper portions of the left and right lumbar wires 36 in a state slightly stretched from its natural state. Tension is applied thereby in a direction in which the left and right lumbar wires 36 approach each other, and rattling between the left and right lumbar wires 36 and the upper bracket 32 is prevented. A length direction intermediate portion of the rubber member 90 is in contact with the case 68 of the air moving machine 66 from the rear side. The rubber member 90 configures a “seatback air moving machine protection structure” of the present disclosure together with the left and right lumbar wires 36, the attachment wire 80, the attachment bracket 62, and the air moving machine 66.

Note that the attachment bracket 62 may be configured directly supported by (directly attached to) the left and right lumbar wires 36 and not through the attachment wire 80. Moreover, the protection member is not limited to being configured from a cloth-form material, and may be configured from a rubber or elastomer. The protection member is also not limited to being a member exhibiting elasticity, and may be a member lacking elasticity.

In the vehicle seat 10 configured as described above, the back of an occupant seated on the seat cushion 12 is supported by the seatback 14. The left and right lumbar wires 36 span between the upper section and the lower section of the seatback frame 22, and the attachment wire 80 is supported by the left and right lumbar wires 36. The attachment bracket 62 is attached to the attachment wire 80, and the air moving machine 66 is attached to a face on the rear side of the attachment bracket 62.

The rubber member 90 formed in a strip shape is arranged at the rear side of the air moving machine 66. The rubber member 90 spans between the left and right lumbar wires 36. This means that the air moving machine 66 can be prevented or suppressed from detaching from the attachment bracket 62 when excessive load is imparted to the seatback 14 from the front side.

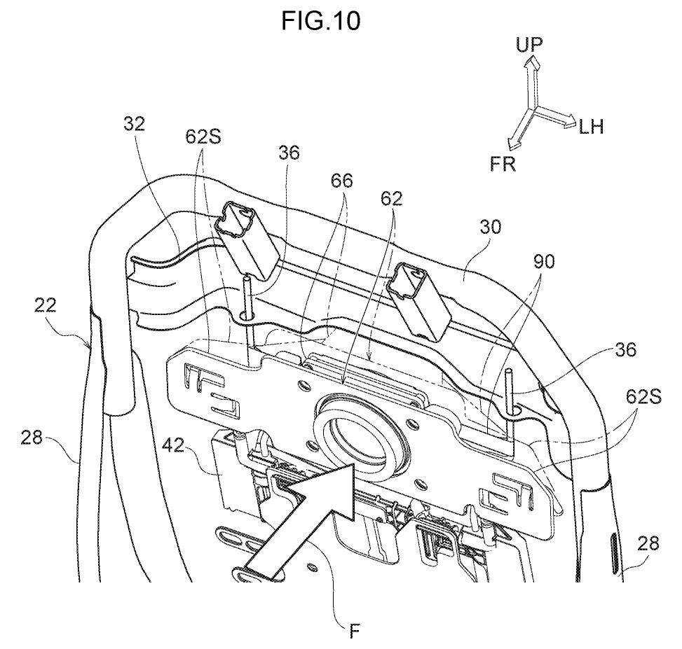

Namely, when the weight of the body of an occupant is imparted to directly above the air moving machine 66, for example when the occupant kneels on the reclined seatback 14 (see arrow F in FIG. 10), an attachment section (namely, the fastening tabs 72 and the fastening seats 74) between the air moving machine 66 and the attachment bracket 62 might be broken, however, this can be prevented or suppressed in the present exemplary embodiment. This thereby enables the air moving machine 66 to be prevented or suppressed from separating from the attachment bracket 62, enables a gap to be prevented or suppressed from opening between the air moving machine 66 and the attachment bracket 62, and enables the air moving machine 66 to be prevented or suppressed from sucking in secondary air from the gap. As a result thereof, the comfort (cool feeling) of the occupant can be secured, and a rise in noise from the air moving machine 66 can be suppressed.

Moreover, in the present exemplary embodiment, the rubber member 90 spans between the left and right lumbar wires 36, and the installation space of the rubber member 90 can be reduced compared to a configuration in which the rubber member 90 spans between the left and right side frames 28 of the seatback frame 22.

Furthermore, in the present exemplary embodiment, the rubber member 90 can be made lighter in weight because the rubber member 90 formed in a strip shape is configured from a cloth-form material. Moreover, the air moving machine 66 can be protected from light loads (for example, the kicking of an infant seated on a child seat attached to a rear seat) input from the back face side of the seatback 14.

Moreover, in the present exemplary embodiment, the rubber member 90 exhibits elasticity, and is able to move in the height direction relative to the left and right lumbar wires 36. This means that the rubber member 90 is not liable to get in the way when the air moving machine 66 is being attached to the attachment bracket. Moreover, due to the rubber member 90 extending under load from the occupant, a configuration can be achieved so as not to impede flexing of the seatback 14 during normal use. Furthermore, the seating comfort of an occupant leaning against the seatback 14 can be controlled by the elasticity (spring constant) of the rubber member 90. Moreover, due to the rubber member 90 extending during a rear-end collision of a vehicle, a configuration in which the ability to prevent whiplash of the head of the occupant is not affected can be achieved.

Moreover, in the present exemplary embodiment, due to the rubber member 90 spanning between the left and right lumbar wires 36, rattling of the left and right lumbar wires 36 with respect to the frame of the seatback 14 can be suppressed. As a result thereof, vibration of the seatback 14 arising from the air moving machine can be reduced.

Next, description follows regarding other exemplary embodiments of the present disclosure. Note that configuration and operation fundamentally the same as that of the first exemplary embodiment will be appended with the same reference numerals as those of the first exemplary embodiment, and duplicate explanation thereof will be omitted.

### Second Exemplary Embodiment

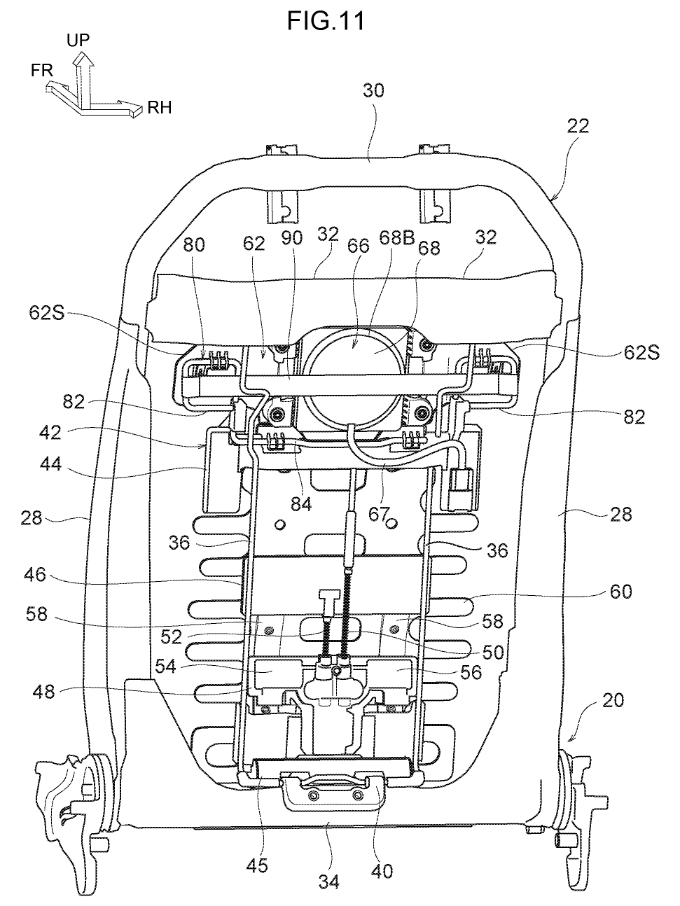

FIG. 11 is a perspective view illustrating part of a seatback of a vehicle seat according to a second exemplary embodiment of the present disclosure. In this exemplary embodiment, the rubber member 90 is spanning between two left and right side portions of the attachment wire 80. The two length direction end portions of the rubber member 90 are anchored to second vertical extension portions 82C of the left and right attachment sections 82 of the attachment wire 80. Note that the two length direction end portions of the rubber member 90 may be configured anchored to the first vertical extension portion 82A of the left and right attachment sections 82. Other configuration of the present exemplary embodiment is similar to that of the first exemplary embodiment. This exemplary embodiment also exhibits advantageous effects basically the same as those of the first exemplary embodiment.

### Third Exemplary Embodiment

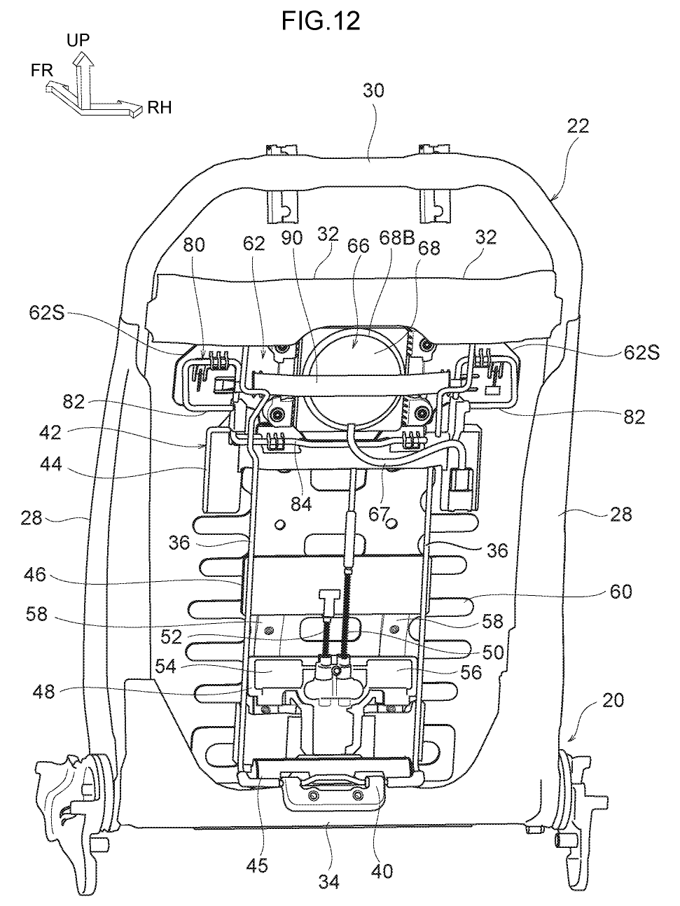

FIG. 12 is a perspective view illustrating part of a seatback of a vehicle seat according to a third exemplary embodiment of the present disclosure. In this exemplary embodiment the rubber member 90 spans between left and right side portions of the attachment bracket 62. The two length direction end portions of the rubber member 90 are inserted into slits (reference numerals omitted) formed in the left and right side portions of the attachment bracket, and are anchored to the attachment bracket 62. Other configuration of the present exemplary embodiment is similar to that of the first exemplary embodiment. This exemplary embodiment also exhibits advantageous effects basically the same as those of the first exemplary embodiment.

Note that although each of the above exemplary embodiments have been described for cases in which the present disclosure is applied to a vehicle seat 10, there is no limitation thereto, and the present disclosure is applicable to a transportation seat other than in a vehicle (such as in an aircraft or a ship).

In addition thereto, various other modifications may be implemented for the present disclosure within a range not departing from the spirit thereof. Moreover, obviously the scope of rights of the present disclosure is not limited to the above exemplary embodiments.

What is claimed is:

1. A seatback air moving machine protection structure comprising:
left and right lumbar wires spanned between an upper section and a lower section of a seatback frame of a vehicle seat;
an attachment wire supported by the left and right lumbar wires;
an attachment bracket attached to the attachment wire;
an air moving machine attached to a face on a seatback rear side of the attachment bracket; and
a protection member that is formed in a strip shape, and that is arranged at the seatback rear side with respect to the air moving machine spanned between the left and right lumbar wires, between left and right side portions of the attachment wire, or between left and right side portions of the attachment bracket.

2. The seatback air moving machine protection structure of claim 1, wherein the protection member is configured from a cloth-form material.

3. The seatback air moving machine protection structure of claim 1, wherein the protection member exhibits elasticity.

4. The seatback air moving machine protection structure of claim 1, wherein the protection member is spanned between the left and right lumbar wires.

5. A seatback air moving machine protection structure comprising:
left and right lumbar wires spanned between an upper section and a lower section of a seatback frame of a vehicle seat;
an attachment bracket supported by the left and right lumbar wires;
an air moving machine attached to a face on a seatback rear side of the attachment bracket; and
a protection member that is formed in a strip shape and is arranged at the seatback rear side with respect to the air moving machine spanned between the left and right lumbar wires.

6. A vehicle seat comprising:
a seat cushion for an occupant of a vehicle to sit on; and
a seatback to support a back of the occupant,
wherein the seatback includes the seatback air moving machine protection structure of claim 1.

7. A vehicle seat comprising:
a seat cushion for an occupant of a vehicle to sit on; and
a seatback to support a back of the occupant,
wherein the seatback includes the seatback air moving machine protection structure of claim 5.
